(19) United States
(12) Patent Application Publication
(10) Pub. No.: US 2009/0195899 A1
(43) Pub. Date: Aug. 6, 2009

(54) Mirror Module for Fastening to a Structural Element

(75) Inventors: Michael KERSTEN, Salem (DE); Guenther Kling, Salem (DE); Peter Weimer, Markdorf (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Muenchen (DE)

(21) Appl. No.: 12/363,026

(22) Filed: Jan. 30, 2009

(30) Foreign Application Priority Data
Jan. 31, 2008 (DE) 102008007060.2-51

(51) Int. Cl. G02B 7/192; G02B 7/182

(52) U.S. Cl. 359/848

(57) ABSTRACT

A mirror module for fastening to a structural element, comprises a mirror arrangement that includes at least one mirror stack and a first receiving device for holding the mirror arrangement. Each of the at least one mirror stack comprises at least one individual mirror made of a first material. The first receiving device is made of a second material which has a coefficient of thermal expansion adapted to the first material. For fastening the mirror module to the structural element, a second receiving device made of Invar is provided which holds the first receiving device of the mirror module.

### BACKGROUND AND SUMMARY OF THE INVENTION

This application claims the priority of German patent document 10 2008 007 060.2-51, filed Jan. 31, 2008, the disclosure of which is expressly incorporated by reference herein.

The present invention relates to a mirror for fastening to a structural element, such as a component of a spacecraft. The mirror module comprises a mirror arrangement and a first receiving device for holding the mirror arrangement. The mirror arrangement has at least one mirror stack that includes at least a single mirror made of a first material. Such a module can be used, for example, within the scope of the European Space Agency's XEUS project

In order to measure x-rays reliably using such a mirror module, it is necessary to uncouple it from external forces, such as thermal forces, for all conceivable load-related events. For this purpose, a mirror module is typically fastened to the structural element via two independent holding elements (so-called brackets) consisting of a ceramic material. The highly brittle Cesic material is used as the ceramic material. However, while forces acting upon the mirror module or upon the mirror arrangement can be weakened in this manner, they cannot be completely kept away from the mirror arrangement.

It is therefore an object of the present invention to provide a mirror module having a mirror arrangement that can be reliably insulated with respect to external and internal forces, particularly thermal forces, for a plurality of load-related events.

This and other objects and advantages are achieved by the mirror module according to the invention, which comprises a mirror arrangement and a first receiving device for holding the mirror arrangement. The latter has at least one mirror stack comprising at least an individual mirror made of a first material. According to the invention, the first receiving device is formed of a second material which has a coefficient of thermal expansion adapted to the first material, and where a second receiving device made of Invar is provided for fastening the mirror module to the structural element. The second receiving device holds the first receiving device of the mirror module.

The use of materials which have a mutually adapted coefficient of thermal expansion results in a tension-free connection of the mirror arrangement to the first receiving device for all cases of temperature-related loads. The provision of the second receiving device made of Invar for holding the first receiving device ensures an isostatically stable, thermally uncoupled mounting of the mirror arrangement on the structural element, thereby achieving a complete uncoupling of the mirror arrangement with respect to the structural element, such as CFC. An uncoupling of a thermal type is thereby ensured as well as an uncoupling with respect to loads acting from the outside. The use of materials with an adapted coefficient of thermal expansion (in the operating temperature range to be expected) for the mirror arrangement and the first receiving device, on the one hand, ensures reliable calibration of the mirror module at room temperature and, on the other hand, the defined use at the later usage site at, for example, 60 K. Furthermore, the use of Invar as a mirror module mounting element in the form of a second receiving device considerably reduces an AIV risk and starting risk in comparison with the previously used brittle Cesic ceramic material.

As a result, the efficiency of the mirror arrangement is completely independent for all conceivably occurring temperature-related cases. The use of a second receiving device made of Invar as an isostatic mounting achieves risk-free fastening of the mirror module, so that excellent insulation of the mirror arrangement is achieved with respect to external forces, such as thermal forces.

According to the invention, the first material of the mirror arrangement and the second material of the first receiving device have the same coefficient of thermal expansion and are therefore advantageously even identical (which, however, is not absolutely necessary). The first material of the mirror arrangement and the second material of the receiving device preferably each consist of silicon.

In a further advantageous embodiment, the mirror arrangement is glued to the first receiving device. Moreover, the first receiving device may have a U-shaped construction, with the mirror arrangement resting on legs of the first receiving device and a leg-connecting surface section. Advantageously, the mirror arrangement is glued to the first receiving device only in the area of the legs, and not in the area of the surface section.

According to a further embodiment, the second receiving device is connected with a centrally arranged fastening device of the first receiving device. The second receiving device is connected with the first receiving device, particularly exclusively, on the back of the mirror arrangement (on the first receiving device). This type of fastening in the center of the second receiving device ensures isostatic, thermostable mounting of the mirror arrangement. Loads from the outside are thereby reliably uncoupled from the mirror arrangement.

In another embodiment, the central fastening device comprises a fastening web which projects into a groove of the second receiving device when the first and the second receiving devices are connected with one another, with the first and the second receiving device being connected in the area of these elements. This ensures a simple reliable mutual fastening of the first and the second receiving device.

The central fastening device also comprises a contact surface, which extends transversely with respect to the fastening web, by which the second receiving device is connected. The provision of the contact surface permits a defined enlargement of the connection surface of the first and the second receiving device.

In order to absorb pitching moments, the first receiving device has supports which are connected with the second receiving device at respective section surfaces.

Preferably, the first and the second receiving devices are glued together.

In a further advantageous embodiment, the second receiving device has a horseshoe-shaped construction and rests against the surface section of the first receiving device. Optionally, the second receiving device is connected at least in sections with the surface section of the first receiving device.

It is further provided that a gap is formed between the first and second receiving devices in the area of the legs of the first receiving device. This means that the side walls or legs of the horseshoe-shaped second receiving device are not connected with the first receiving device and are thereby uncoupled from the first receiving devices in this area.

In order to ensure flexural strength and resistance to torsion of the second receiving device, the second receiving device is constructed as a closed square profile in its cross-section.

In a further concrete embodiment, the mirror arrangement comprises two mirror stacks oriented at a defined angle with respect to one another. In this case, each of the mirror stacks comprises 45 individual mirrors with a porous lens system made of silicon.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of a mirror module according to the invention, arranged on a second receiving device;

FIG. 2 is a top view of the arrangement illustrated in FIG. 1;

FIG. 3 is an exploded view of the mirror module and of the second receiving device of FIG. 1; and

FIG. 4 is an exploded view from below of the mirror module and of the second receiving device of FIG. 1.

### DETAILED DESCRIPTION OF THE DRAWINGS

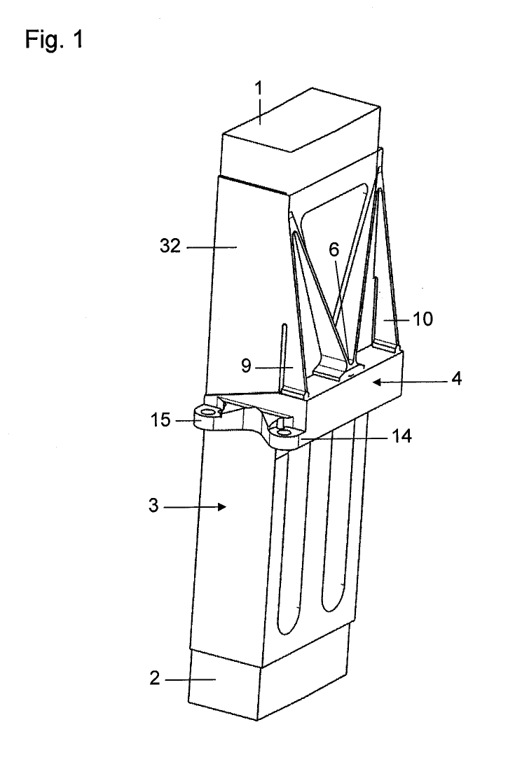

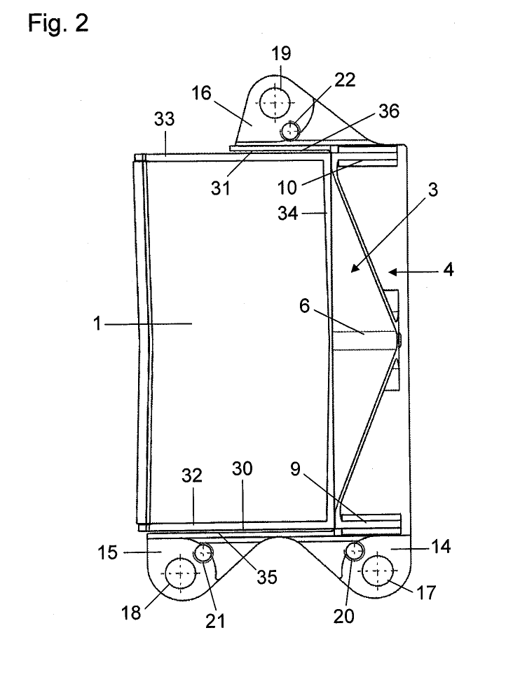

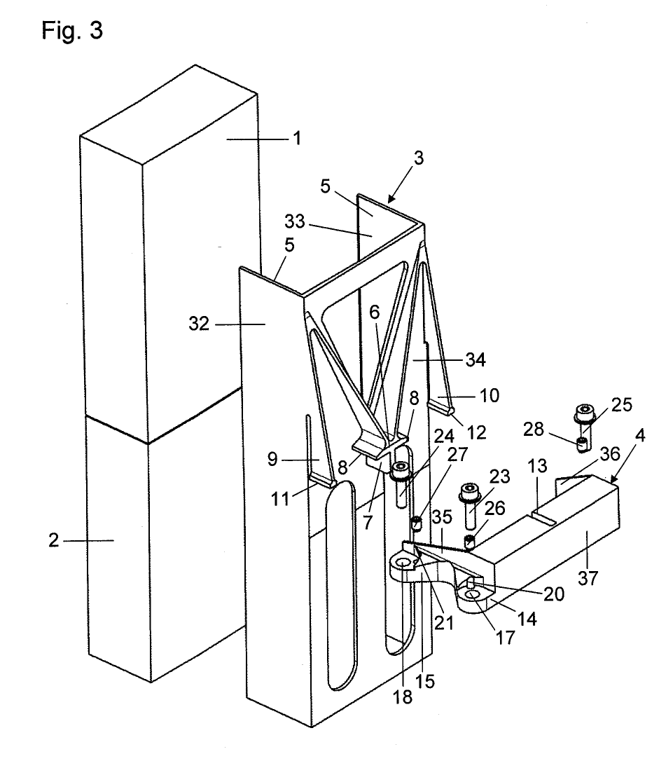

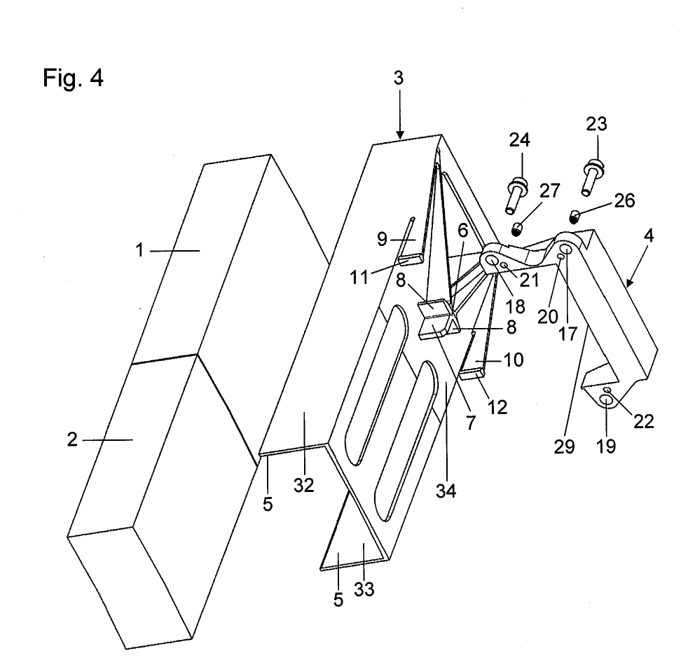

FIGS. 1 to 4 illustrate a mirror module according to the invention for fastening to a structural element (not shown in the figures) of a spacecraft. The mirror module comprises a mirror arrangement with two mirror stacks 1,2, each of which comprises, for example, 45 individual mirrors respectively which have a porous lens system. Each individual mirror (and thus the mirror stack 1, 2) is made of silicon. The two mirror stacks 1, 2 mutually oriented at a defined angle are fastened to a first receiving device 3. As illustrated particularly in the top view of FIG. 2, the first receiving device 3 has a U-shaped cross-section; the mirror stacks 1, 2 rest on legs 32, 33 as well as on a surface section 34 connecting the legs. The mirror stacks 1, 2 are connected with the first receiving device 3 in the area of the legs 32, 33 by adhesive. The first receiving device is also made of silicon, in order to provide a coefficient of thermal expansion adapted to the material of the mirror stacks 1, 2, so that an identical linear expansion of these two components is ensured for all temperature-related load events. The first receiving device 3 is integrally milled from silicon.

As illustrated by the perspective views of FIGS. 1, 3 and 4, the first receiving device 3 comprises a centrally arranged central fastening device 6 on the surface section 34 on the back side, and a fastening web 7 extends away from the central fastening device 6. A contact surface 8 extends transversely with respect to the fastening web 7. Supports 9, 10 are arranged at the respective outer edges of the surface section 34, which supports 9, 10 each have a supporting surface 11, 12 situated in a plane with the contact surface 8. The supports 9, 10 are at least partially spaced away from the surface section 34 of the first receiving device 3 by a slot, so that they have a certain flexibility transversely to the plane of the surface section 34.

The first receiving device 3 with the mirror stacks 1, 2 arranged thereon is connected at the central fastening device 6, particularly the fastening web 7, with a correspondingly further developed second receiving device 4. The second receiving device 4 is made of Invar, a nickel-iron alloy which has very low or partially negative coefficients of thermal expansion.

The second receiving device 4 has a horseshoe-shaped construction (top view in FIG. 2), and its external dimensions are adapted to the dimensions of the U-shaped first receiving device 3. A web 37 connecting legs 35, 36 has a cross-section constructed as a closed square profile, so that the second receiving device becomes resistant to torsion and bending. In the area of the fastening web 7 of the central fastening device of the first receiving device 3, the web 37 of the second receiving device 4 has a groove 13. The fastening web 7 projects into the groove 13, so that, after the assembly of the first and second receiving device 3, 4, the web 37 rests on the surface section 34. The first and the second receiving devices 3, 4 are mechanically connected (glued) between the fastening web 7 and the corresponding groove 13 as well as the supporting surfaces 11, 12 and the web 37. Optionally, a connection can also be established between the contact surface 8 and the top side of the web 37.

The contact surface 8 has a width of approximately 1.5 cm. It is used as a contact surface (and, as required, an adhesive surface) with respect to the second receiving device 4 (i.e., its web 37). The risk of excessive shearing stress is minimized even at high temperature fluctuations, which shearing stress is caused by different coefficients of linear expansion between silicon and Invar is minimized, even at high temperature fluctuations, by the central connection of the first receiving device 3 with the second receiving device 4 with a preferably maximal gluing length of approximately 2 cm.

The supports 9, 10 are used for absorbing pitching moments. For this purpose, their supporting surfaces 11, 12 are also glued to the web 37 of the second receiving device 34. A different linear expansion in the transverse direction is taken into account by a corresponding bending softness of the laterally slotted supports 9, 10.

The legs 35, 36 of the second receiving device 4 are not connected with the legs 32, 33 of the first receiving device 3. Rather, a gap 30 and 31 respectively is formed between the respective legs 32, 35 and 33, 36 respectively.

A load connection of the first receiving device with the second receiving device 4 to the central fastening device 6, which represents the central connection point, takes place only by way of the closed square profile; (that is, the web 37, of the second receiving device 4. Here, the connection is implemented on the back of the mirror stacks 1, 2.

Fastening of the mirror module to a structural element of a spacecraft provides an isostatic thermostable mounting with a center in the middle of the second receiving device 4. As a result, loads from the outside are reliably uncoupled from the mirror stacks 1, 2.

The linkage of such a prepared mirror module takes place by fastening flanges 14, 15, 16 constructed on the legs 35, 36. A bore 17, 18, 19 is provided in each of the fastening flanges 14, 15, 16, so that the second receiving device 4 can be fastened by fastening screws 23, 24, 25 to the structural element not shown in the figures. The provision of two fastening flanges 14, 15 on leg 35 and of one fastening flange 16 on leg 36 provides a so-called 3-point bearing.

Before the final fastening of the mirror stacks 1, 2, they can be aligned laterally by way of the bores 17, 18, 19 and aligned angularly by way of ball thrust fine-pitch thread screws. For this purpose, fine-pitch thread bores 20, 21, 22 are provided in the fastening flanges 14,15, 16. The ball thrust screws 26, 27, 28 can be screwed into the bores 20, 21, 22 for alignment.

The described mirror module ensures complete uncoupling of the mirror mounting (i.e., of the first fastening device 3, with respect to the structural element, such as CFC) by the isostatic insertion of the second receiving device made of Invar. This applies to thermal loads as well as to mechanical loads acting from the outside. The use of the same material for the mirror stacks 1, 2 and the first receiving device 3, together with the use of Invar as material for the isostatic mounting by means of the second receiving device 4 ensures a reliable calibration of the lens system in a room temperature environment, and likewise defined conditions at their later usage site at, for example, 60 K. As a result, the efficiency of the mirror stacks 1, 2 is completely independent for all occurring temperature-related events. The use of a second receiving device 4 made of Invar as an isostatic mounting achieves risk-free fastening of the mirror stacks 1, 2, and provides an excellent insulation of the mirror stacks with respect to external forces.

### LIST OF REFERENCE NUMBERS

1 Mirror Stack
2 Mirror Stack
3 First Receiving Device
4 Second Receiving Device
5 Side Wall of the First Receiving Device
6 Central Fastening Device
7 Fastening Web
8 Contact Surface
9 Support
10 Support
11 Supporting Surface
12 Supporting Surface
13 Groove
14 Fastening Flange
15 Fastening Flange
16 Fastening Flange
17 Bore
18 Bore
19 Bore
20 Fine-Pitch Thread Bore
21 Fine-Pitch Thread Bore
22 Fine-Pitch Thread Bore
23 Fastening Screw
24 Fastening Screw
25 Fastening Screw
26 Ball Thrust Screw
27 Ball Thrust Screw
28 Ball Thrust Screw
29 Contact Surface
30 Gap
31 Gap
32 Leg
33 Leg
34 Surface Section
35 Leg
36 Leg
37 Web

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A mirror module for fastening to a structural element, said mirror module comprising:
a mirror arrangement which has at least one mirror stack that includes at least one individual mirror made of a first material; and
a first receiving device for holding the mirror arrangement; wherein,
the first receiving device is made of a second material which has a coefficient of thermal expansion that is adapted to the first material; and
for fastening the mirror module to the structural element, the mirror module further comprises a second receiving device made of Invar, which holds the first receiving device of the mirror module.

2. The mirror module according to claim 1, wherein both the first material and the second material are silicon.

3. The mirror module according to claim 1, wherein the mirror arrangement is glued to the first receiving device.

4. The mirror module according to claim 1, wherein:
the first receiving device has a U-shaped construction; and
the mirror arrangement rests on legs of the first receiving device and on a surface section which connects the legs.

5. The mirror module according to claim 4, wherein the mirror arrangement is glued to the first receiving device only in an area of the legs.

6. The mirror module according to claim 1, wherein the second receiving device is connected with a centrally arranged fastening device of the first receiving device.

7. The mirror module according to claim 1, wherein the second receiving device is connected with the first receiving device, only on a back of the mirror arrangement.

8. The mirror module according to claim 6, wherein:
the central fastening device comprises a fastening web which projects into a groove of the second receiving device when the first and the second receiving device are connected with one another; and
the first and second receiving devices are connected in an area of these elements.

9. The mirror module according to claim 8, wherein the central fastening device comprises a contact surface that extends transversely with respect to the fastening web with which the second receiving device is connected.

10. The mirror module according to claim 1, wherein:
the first receiving device has supports on a surface section thereof; and
said supports are connected on respective supporting surfaces with the second receiving device.

11. The mirror module according to claim 1, wherein the first and second receiving devices are glued to one another.

12. The mirror module according to claim 1, wherein:
the second receiving device has a horseshoe-shaped construction and rests against the surface section of the first receiving device; and
the second receiving device is connected at least in part with the surface section.

13. The mirror module according to claim 4, wherein a gap is formed between the first and the second receiving device in the area of the legs of the first receiving device.

14. The mirror module according to claim 1, wherein the second receiving device is constructed as a closed square profile in its cross-section.

15. The mirror module according to claim 1, wherein the mirror arrangement comprises two mirror stacks oriented at a defined angle with respect to one another.

16. The mirror module according to claim 1, wherein each mirror stack comprises 45 individual mirrors with a porous lens system made of silicon.
